(19) United States
(12) Patent Application Publication
(10) Pub. No.: US 2005/0239991 A1
(43) Pub. Date: Oct. 27, 2005

(54) Method of producing a urethane acrylate

(75) Inventors: David D. Peters, Wyandotte, MI (US); Calvin T. Peeler, Canton, MI (US)

Correspondence Address: BASF AKTIENGESELLSCHAFT, CARL-BOSCH STRASSE 38, 67056 LUDWIGSHAFEN, LUDWIGSHAFEN, 69056, DE

(73) Assignee: BASF Corporation.

(21) Appl. No.: 11/088,531

(22) Filed: Mar. 24, 2005

Related U.S. Application Data
(63) Continuation-in-part of application No. 10/832,903, filed on Apr. 27, 2004.
(63) Continuation-in-part of application No. 10/935,437, filed on Sep. 7, 2004.
Application No. 10/935,437 is a continuation-in-part of application No. 10/935,549, filed on Sep. 7, 2004.

(51) Int. Cl. C08G 18/00

(52) U.S. Cl. 528/44

(57) ABSTRACT

A method of producing a urethane acrylate that is the reaction product of an isocyanate component and a functionalized acrylate component includes charging a reactor with the functionalized acrylate component. An inhibitor is combined with the functionalized acrylate component. The isocyanate component and the functionalized acrylate component are reacted together in the presence of the inhibitor to produce the urethane acrylate. A reaction temperature is maintained at less than 60° C. in the reactor throughout the step of reacting the isocyanate component with the functionalized acrylate component. The urethane acrylate exhibits excellent stability over time.

### RELATED APPLICATIONS

This application is a continuation-in-part of co-pending U.S. patent application Ser. Nos. 10/832,903, 10/935,437, and 10/935,549, which were filed on Apr. 27, 2004, Sep. 7, 2004, and Sep. 7, 2004, respectively.

### FIELD OF THE INVENTION

The present invention generally relates to a method of producing a urethane acrylate. More specifically, the method of producing the urethane acrylate results in a composition that exhibits excellent stability over time.

### BACKGROUND OF THE INVENTION

Urethane acrylates are known in the art, as are methods of producing the urethane acrylates. The urethane acrylate is the reaction product of an isocyanate component and a functionalized acrylate component that is reactive with the isocyanate component. Urethane acrylates can be used in a variety of products, including structural composites. The methods of producing the urethane acrylates generally include charging a reactor with a functionalized acrylate component and an isocyanate component and reacting these components at elevated temperatures, in excess of 60° C., for a sufficient amount of time to consume, or react, all of the free isocyanate groups of the isocyanate component.

U.S. Pat. No. Re. 35,280 discloses a method of producing a urethane acrylate by the reaction of an isocyanate component with a functionalized acrylate component in the presence of hydroquinone, which is a non-sterically hindered inhibitor, and dibutyl tin dilaurate, which is a typical urethane catalyst. In the method, the isocyanate component is mixed with the inhibitor and the urethane catalyst. The functionalized acrylate component is added to this mixture. Upon the addition of the functionalized acrylate component, the isocyanate component reacts with the functionalized acrylate component. Due to the exothermic nature of the reaction between the isocyanate component and the functionalized acrylate component, the mixture rapidly heats to a temperature of about 75° C. After the addition of the functionalized acrylate component is complete the reaction mixture is heated to about 90° C. for a period of about 360 minutes, during which time all free isocyanate groups are consumed. However, under these reaction conditions, and due to the choice of inhibitors, the inhibitor reacts with the isocyanate component. Thus, the inhibitor would be consumed and, therefore, would no longer be effective. As a result, the urethane acrylate would be unstable over time. More specifically, the '280 urethane acrylate would develop visible separation and solids within a maximum of two weeks at about 20° C. and forms a solid gel shortly thereafter. The gelation is accelerated if the urethane acrylate is heated. Since urethane acrylates are frequently stored for more than four weeks before use, products formed from the method of the '280 patent are not appropriate for many industrial applications. Further, HEMA can auto-polymerize at temperatures above 80° C. As a result, the examples described in the '280 patent can exhibit batch-to-batch variation in viscosity, potentially reducing storage stability, and potentially adversely impacting other material properties.

Likewise, Japanese Patent No. 04202073 discloses a similar method of producing the urethane acrylate. In the '073 patent, polymethylene polyphenyl polyisocyanate, i.e., the isocyanate component, is added to a mixture of HEMA, i.e., the functionalized acrylate component, and hydroquinone, i.e., the inhibitor. Again, the method is carried out at elevated temperatures and utilizes the exothermic nature of the reaction to heat the reaction mixture to a target of 60° C. As with the '280 patent, the inhibitor also reacts with the isocyanate component at the reaction temperature of 60° C. Thus, the inhibitor is consumed during the reaction and the urethane acrylate is similarly unstable over time.

Further, it was discovered that addition of the inhibitor to the urethane acrylate after completion of the reaction between the isocyanate component and the functionalized acrylate component is an ineffective solution for improving the stability of the urethane acrylate. If the inhibitor is not present during the exothermic reaction between the functionalized acrylate component and the isocyanate component, unwanted side reactions occur. Such side reactions also result in instability of the urethane acrylate. Examples of unwanted side reactions include, but are not limited to, the thermal generation of radicals resulting in undesired auto-polymerization of the urethane acrylate and/or the functionalized acrylate component and possible Michaels-type reactions or nucleophilic addition reactions of the carbamate to the acrylate component.

Due to the deficiencies of the prior art, including those described above, it is desirable to provide a unique method of producing urethane acrylate that exhibits excellent stability over time.

### SUMMARY OF THE INVENTION AND ADVANTAGES

The subject invention provides a method of producing a urethane acrylate. The urethane acrylate is the reaction product of an isocyanate component and a functionalized acrylate component. For the method, a reactor is charged with the functionalized acrylate component. An inhibitor is combined with the functionalized acrylate component. The isocyanate component and the functionalized acrylate component are reacted together in the presence of the inhibitor to produce the urethane acrylate. Throughout the step of reacting the isocyanate component with the functionalized acrylate component, a reaction temperature is maintained at less than 60° C. in the reactor.

This method produces a urethane acrylate that exhibits excellent stability over time. More specifically, the reaction temperature of less than 60° C. is sufficiently low to minimize unwanted side reactions between the inhibitor and the isocyanate component. Thus, the inhibitor remains unreacted in the final urethane acrylate. As a result, the urethane acrylate exhibits excellent storage stability.

### DETAILED DESCRIPTION OF A PREFERRED EMBODIMENT

The subject invention provides a method of producing a urethane acrylate. The urethane acrylate is the reaction product of an isocyanate component and a functionalized acrylate component that is reactive with the isocyanate component. The urethane acrylate may be used in a wide variety of application areas including coating applications and, in particular, structural composites.

Depending on the intended use of the urethane acrylate, the isocyanate component may be selected from a wide variety of isocyanates including, but not limited to, aliphatic isocyanates, aromatic isocyanates, isocyanate-capped quasi pre-polymers based on either aliphatic or aromatic isocyanates, other modified isocyanates not discussed herein, and combinations of any of those isocyanates. Preferably, the isocyanate component has at least two isocyanate groups, which provide polymeric functionality to the urethane acrylate. In a more preferred embodiment, the isocyanate component has from two to three isocyanate groups.

Whenever the term aliphatic is used throughout the subject application, it is intended to indicate any combination of aliphatic, acyclic, and cyclic arrangements. That is, aliphatic indicates both straight chains and branched arrangements of carbon atoms (non-cyclic) as well as arrangements of carbon atoms in closed ring structures (cyclic) so long as these arrangements are not aromatic.

Suitable aliphatic and modified aliphatic isocyanates for the isocyanate component include, but are not limited to, hexamethylene diisocyanate (HDI), isophorone diisocyanate (IPDI), dicyclohexane-4,4′ diisocyanate (Desmodur W), hexamethylene diisocyanate trimer (HDI Trimer), isophorone diisocyanate trimer (IPDI Trimer), hexamethylene diisocyanate biuret (HDI Biuret), cyclohexane diisocyanate, meta-tetramethylxylene diisocyanate (TMXDI), and mixtures thereof. Additionally, it is to be understood that the isocyanate component may be a pre-polymer based on, but not limited to, any of the aforementioned aliphatic isocyanates or derivatives.

Suitable aromatic isocyanates for use as the isocyanate component of the urethane acrylate can be selected from, but are not limited to, the group of toluene diisocyanates, polymeric diphenylmethane diisocyanates, diphenylmethane diisocyanates, prepolymers based on the aforementioned isocyanates, modified isocyanates and combinations thereof. In a most preferred embodiment, the isocyanate component is a polymeric diphenylmethane diisocyanate. Specific examples of preferred isocyanate components suitable for the urethane acrylate include, but are not limited to, Lupranate® M20S isocyanate, Lupranate® MI isocyanate, Lupranate® M70R isocyanate, Lupranate® M200 isocyanate, Lupranate® T-80 isocyanate and ELASTOFLEX® R23000 isocyanate. All are commercially available from BASF Corporation. As alluded to above, the isocyanate component may comprise a combination of isocyanates. That is, a blend of at least two isocyanates may be utilized for reaction with the acrylate component to form the urethane acrylate.

Other suitable isocyanate components include, but are not limited to, conventional aliphatic, cycloaliphatic, araliphatic and aromatic isocyanates. Specific examples include: alkylene diisocyanates with 4 to 12 carbons in the alkylene radical such as 1,12-dodecane diisocyanate, 2-ethyl-1,4-tetramethylene diisocyanate, 2-methyl-1,5-pentamethylene diisocyanate, 1,4-tetramethylene diisocyanate, 1,6-hexamethylene diisocyanate; cycloaliphatic diisocyanates such as 1,3- and 1,4-cyclohexane diisocyanate as well as any mixtures of these isomers, 1-isocyanato-3,3,5-trimethyl-5-isocyanatomethylcyclohexane (isophorone diisocyanate), 2,4- and 2,6-hexahydrotoluene diisocyanate as well as the corresponding isomeric mixtures, 4,4′-2,2′-, and 2,4′-dicyclohexylmethane diisocyanate as well as the corresponding isomeric mixtures, aromatic diisocyanates such as 2,4- and 2,6-toluene diisocyanate and the corresponding isomeric mixtures, 4,4′-, 2,4′-, and 2,2′-diphenylmethane diisocyanate and the corresponding isomeric mixtures, as well as mixtures of any of the aforementioned isocyanate components.

A structural composite requiring UV stability is a primary example of an application area that would affect the selection of the isocyanate component. Parts that are directly exposed to sunlight or other sources of UV radiation tend to discolor if aromatic isocyanates are employed. Urethane acrylates that are the reaction product of the aliphatic isocyanates are more stable to UV light than urethane acrylates that are the reaction product of the aromatic isocyanates. However, the isocyanate component may also include aromatic isocyanates so long as at least one UV performance-enhancing additive is included such that the urethane acrylate article demonstrates suitable stability under exposure to UV light. For coatings and structural composites formed from the urethane acrylate where UV stability is not critical, aliphatic isocyanates are not required. Other criteria that could affect the selection of the isocyanate component include, but are not limited to, a targeted heat distortion temperature, elongation, strength, hardness and other physical properties of the urethane acrylate not discussed herein.

The functionalized acrylate component set forth above includes at least one functional group that is reactive with at least one of the isocyanate groups of the isocyanate component. Preferably, the functionalized acrylate component has from one to four olefinic functional groups and from one to four isocyanate reactive functional groups. In a more preferred embodiment, the functionalized acrylate component includes a single isocyanate-reactive functional group and from one to four olefinic functional groups. In a most preferred embodiment, the functionalized acrylate component has one olefinic functional group and one isocyanate-reactive functional group for providing sufficiently low viscosity to the urethane acrylate, to be described in further detail below.

Preferably, the isocyanate-reactive functional group is selected from the group of hydroxy-functional groups, amine-functional groups, and combinations thereof. Suitable hydroxy-functional groups include hydroxy-functional alkyl groups having from one to twenty carbon atoms. Specific examples of functionalized acrylate components including suitable hydroxy-functional groups include hydroxymethyl, hydroxyethyl, hydroxypropyl, and hydroxybutyl acrylates and alkacrylates, and combinations thereof. It is to be appreciated that the acrylates may include more than one of the aforementioned hydroxy-functional groups and may be incorporated as the poly-functional alcohol portion of the isocyanate-capped quasi prepolymer as described above.

Preferably, the functionalized acrylate component includes at least one alkyl group having from one to twenty carbon atoms. Specific examples of functionalized acrylate components including suitable alkyl groups include methacrylates, ethacrylates, propacrylates, butacrylates, phenylacrylates, methacrylamides, ethacrylamides, butacrylamides, and combinations thereof.

Preferred functionalized acrylate components include hydroxymethyl methacrylate, hydroxyethyl methacrylate, hydroxypropyl methacrylate, hydroxymethyl ethacrylate, hydroxyethyl ethacrylate, hydroxypropyl ethacrylate, glycerol dimethacrylate, N-methylol methacrylamide, 2-tert-butyl aminoethyl methacrylate, dimethylaminopropyl methacrylamide, and combinations thereof. In a most preferred embodiment, the functionalized acrylate component is a hydroxyethyl methacrylate. It is to be appreciated that the functionalized alkylacrylates and functionalized acrylates may be used interchangeably, i.e., hydroxyethyl acrylate may be used in place of hydroxyethyl methacrylate and vice versa.

Alternatively, a reactive diluent other than the functionalized acrylate component may be added to the urethane acrylate primarily to further lower the viscosity of the resulting urethane acrylate. The reactive diluent has at least one acrylate-reactive unsaturated functional group selected from the group of vinyl, allyl, cyclic allyl, cyclic vinyl, acrylic, functionalized and non-functionalized acrylic, acrylamides, acrylonitrile, and combinations thereof. Specific examples of reactive diluents that are suitable for the subject invention include, but not limited to styrene, divinyl benzene, vinyl toluene, diacetone acrylamide, acrylonitrile, methyl methacrylate, hydroxyethyl methacrylate, hydroxypropyl methacrylate, alpha methyl styrene, butyl styrene, monochlorostyrene, diallyl phthalate and combinations thereof. In terms of actual amounts by weight, the reactive diluent is preferably present in an amount of at least 1.0 part by weight, more preferably from 1.0 to 40 parts by weight, most preferably from 5 to 25 parts by weight based on the total weight of the urethane acrylate.

The method of the subject invention is performed in a temperature-controlled reactor with the ability to heat and cool the reaction mixture to within 5° C. of a desired temperature during the method. Preferably, the reactor conforms to all standard good laboratory and industrial practices with regards to construction, temperature control, material flow, material addition controls, and safety considerations.

The method begins with preparation of the reactor. Preferably, the reactor is clean and free of all possible contaminates that could affect the urethane acrylate to be prepared. As a first step, the reactor is cleaned in a typical industrial process, washed with water and/or solvent and then flushed with a portion of the functionalized acrylate component and purged with air. Preferably, the air is free of moisture to prevent introduction of contaminants in the reactor from the air itself.

The reactor is charged with the functionalized acrylate component. In one embodiment, a temperature of the reactor may be above 20° C. due to prior use of the reactor. Preferably, the functionalized acrylate component and the reactor are cooled to a temperature of less than 20° C. prior to reacting the isocyanate component and the functionalized acrylate component. The functionalized acrylate component and the reactor are cooled to aid in temperature control during the addition of the isocyanate component, which will be described in further detail below. In another embodiment, the reactor may already be at a temperature of less than 20° C., in which case the reactor is maintained at the temperature of less than 20° C. during the charging of the functionalized acrylic component. Regardless of the initial temperature of the reactor, the functionalized acrylate component is preferably less than 20° C. prior to the step of reacting the isocyanate component and the functionalized acrylate component.

An inhibitor is combined with the functionalized acrylate component. Preferably, the inhibitor includes functional groups that are sterically hindered such that the functional groups remain unreacted during the reaction between the isocyanate component and the functionalized acrylate component. The inhibitor is present to aid in the prevention of unwanted side reactions during the reaction between the isocyanate component and the functionalized acrylate component and to preserve the finished urethane acrylate. Due to the sterically hindered nature of the inhibitor, the inhibitor is slow to react with the isocyanate component. As such, it is likely that the functional group of the inhibitor remains unreacted during the reaction between the isocyanate component and the functionalized acrylate component at the reaction temperature of less than 60° C. The preferred hindered inhibitors are discussed in further detail below. Nevertheless, it may be possible to use inhibitors that are unhindered and that remain unreacted during the reaction between the isocyanate component and the functionalized acrylate component by maintaining the reaction temperature substantially below 60° C. By remaining unreacted during the reaction between the isocyanate component and the functionalized acrylate component, the inhibitor is present in the final urethane acrylate. The presence of the inhibitor in the final urethane acrylate results in excellent stability of the urethane acrylate.

The inhibitor more preferably includes a hindered phenol, which is slow to react or non-reactive with the isocyanate component. The rate of reaction can be attributed, but not limited to, the combination of the steric hindrance about the functional group and the acidity of the functional group. However, to further prevent reactions between the inhibitor and the isocyanate groups, in a more preferred embodiment, the inhibitor includes a compound of the formula: 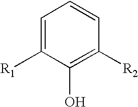
wherein R₁ and R₂ each comprise at least one of an aliphatic group, an aromatic group, and combinations thereof having from one to twenty carbon atoms. Such an inhibitor is commonly referred to as a hindered phenol due to the presence of the R₁ and R₂ groups. In a most preferred embodiment, the hindered phenol includes a compound of the formula: 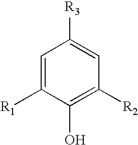
wherein R₁ and R₂ are set forth above and R₃ comprises at least one of an aliphatic group, an aromatic group, a functionalized aromatic or aliphatic group that is unreactive with the isocyanate groups, and combinations thereof. The hindered phenol is less reactive with the isocyanate groups of the isocyanate component than unhindered phenols, such as p-methoxy hydroquinone (MEHQ). More specifically, reactivity of the hindered phenol is further reduced by maintaining the reaction temperature at less than 60° C. The hindered phenol may be combined with the functionalized acrylate component prior to the reaction between the functionalized acrylate component and the isocyanate component such that the hindered phenol is present during the reaction without reacting with the isocyanate component or otherwise interfering with the production of the urethane acrylate. As a result, the hindered phenol imparts excellent storage stability in the final urethane acrylate.

Specific examples of inhibitors that are suitable for the subject invention include, but are not limited to, a 3,5-bis-(1,1-dimethyl-ethyl)-4-hydroxy benzennepropanic ester of a C14-C₁₋₅ alcohol blend, butylated hydroxytoluene, triethylene glycol-bis-3,3-t-butyl-4 hydroxy-5 methyl phenyl propionate, pentaerythritol tetrakis [3-(3,5-di-tert-butyl-4-hydroxphenyl)propionate], octadecyl-3,5-di-(tert)-butyl-4-hydroxyhydrocinnamate, a 3,5-bis(1,1-dimethyl-ethyl)-4-hydroxy-C7-C9 branched alkylester, 2,2′-methylene-bis(6-t-butyl-4-methylphenol), 2,6-di-tertiary-butyl-4-nonylphenol, a butylated reaction product of p-cresol and dicyclopentadiene, tocopherol, and combinations thereof.

Preferably, the inhibitor is combined with the functionalized acrylate component in the reactor at a time sufficiently prior to the addition of the isocyanate component to allow the inhibitor to completely dissolve and/or be mixed throughout the acrylate component. However, it is to be appreciated that the inhibitor may be combined with the functionalized acrylate component any time prior to production of the urethane acrylate so long as the inhibitor is present at a minimum concentration within the mixture of the functionalized acrylate component and the isocyanate component to prevent or minimize the occurrence of the unwanted side reactions. That is, if the inhibitor is added to the acrylate component at a time significantly in advance of the reaction between the isocyanate component and the functionalized acrylate component, the inhibitor may be consumed through oxidative processes known to those skilled in the art. More specifically, the inhibitor may be combined with the functionalized acrylate component prior to the step of charging the reactor with the functionalized acrylate component, concurrent with the step of charging the reactor, and/or during the reaction between the isocyanate component and the functionalized acrylate component, etc. Alternatively, the inhibitor can be split between the functionalized acrylate component and the isocyanate component and added concurrently to the reactor along with the isocyanate component.

Preferably, the method further includes the step of dissolving the inhibitor in at least one of the isocyanate component and the functionalized acrylate component immediately prior to the step of reacting the isocyanate component and the functionalized acrylate component. The step of dissolving the inhibitor functions to sufficiently disperse the inhibitor throughout the urethane acrylate. Most preferably, the inhibitor is dissolved in the functionalized acrylate component while in the reactor. As known to those of skill in the art, agitation is typically used to help dissolve the inhibitor in the functionalized acrylate component. The agitation is typically maintained throughout the step of reacting the isocyanate component and the functionalized acrylate component to aid in mixing the isocyanate component and the functionalized acrylate component and to assist with heat transfer. The agitation may be supplied, depending on the scale of the reaction, by any typical laboratory or industrial agitation method.

Preferably, the inhibitor is present in the urethane acrylate in an amount of from 0.005 to 0.10 parts by weight based on the total weight of the urethane acrylate. More preferably, the inhibitor is present in an amount of from 0.01 to 0.05 parts by weight, most preferably from 0.025 to 0.035 parts by weight, based on the total weight of the urethane acrylate.

As alluded to above, the method further includes the step of reacting the isocyanate component and the functionalized acrylate component in the presence of the inhibitor to produce the urethane acrylate. Preferably, the reaction between the isocyanate component and the functionalized acrylate component occurs in the reactor, with the temperature of the reactor controlled and with agitation of the mixture of the isocyanate component and the functionalized acrylate component in the reactor. In a most preferred embodiment, the isocyanate component is fed into the reactor separate from the functionalized acrylate component and in a manner to aid in controlling the reaction between the isocyanate component and the functionalized acrylate component. However, it is to be understood that the isocyanate component may first be combined with the functionalized acrylate component outside of the reactor. For example, the isocyanate component and the functionalized acrylate component may be combined at an injection nozzle of a loop-type industrial reactor. Such loop-type industrial reactors are known in the art for controlling the temperature in the reactor and for adding additives into the reactor. When the loop-type industrial reactor is used, the reactor is charged with the functionalized acrylate component and combined with the inhibitor and other additives, if desired. The functionalized acrylate component is then pumped through a loop outside of or external to the reactor, and the isocyanate component is fed into the reactor. The functionalized acrylate component is then mixed with the isocyanate component and brought back into the reactor to perform the step of reacting the isocyanate component and the functionalized acrylate component. Thus, the step of charging the reactor with the functionalized acrylate component may be further defined as charging the reactor with the mixture that includes the functionalized acrylate component.

Preferably, the step of feeding the isocyanate component into the reactor occurs over a period of time that is sufficient to prevent the reaction temperature from increasing beyond a temperature of about 35° C. within the reactor, which is typically at least 30 minutes. Thus, feeding the isocyanate component into the reactor over the period of at least 30 minutes aids in controlling the reaction temperature, however, other factors also affect the reaction temperature such as the scale of the reaction, agitation rate, and cooling efficiency. As a result, the time period over which the isocyanate component may be fed into the reactor may be longer than 30 minutes to further maintain the desired reaction temperature.

Upon completion of the addition of the isocyanate component, the reaction temperature is maintained at less than or equal to 60° C. in the reactor throughout the remainder of the reaction between the isocyanate component and the functionalized acrylate component to prevent the inhibitor from being consumed during the reaction. More preferably, the reaction temperature is maintained at less than or equal to 55° C., most preferably at less than or equal to 50° C. More specifically, in the most preferred embodiment, the reaction temperature is maintained at less than or equal to 40° C. throughout the step of feeding the isocyanate component into the reactor. Furthermore, in the most preferred embodiment, the reaction temperature is maintained within a temperature range of from 40 to 50° C. until all free isocyanate groups are consumed in the reactor, which signals an end of the reaction between the isocyanate component and the functionalized acrylate component.

Since the reaction between the isocyanate component and the functionalized acrylate component is an exothermic reaction, the reaction temperature is maintained within the above-stated ranges by cooling the reactor until the rate of reaction and the heat of reaction is insufficient to maintain the desired reaction temperature. If necessary, the reactor may be heated to maintain the reaction temperature within the above-stated ranges. The cooling may be performed by, but is not limited to, passing a stream of water around the reactor, placing ice around the reactor, wrapping a cooling jacket around the reactor, or any other method that is known in the art for cooling reactors. Similarly, the required heating is accomplished by, but not limited to, bathing the reactor in hot water, passing a stream of hot water or steam through or around the reactor, electrical heating elements wrapped around or disposed within the reactor, or any other method that is known in the art.

Infrared (IR) spectroscopy is employed to determine the point at which all free isocyanate groups are consumed in the reactor. More specifically, samples are periodically taken from the reactor, starting at about 120 minutes after the start of the reaction between the isocyanate component and the functionalized acrylate component, i.e., when the isocyanate component is first fed into the reactor or is otherwise combined with the functionalized acrylate component. The samples are subjected to the IR spectroscopy analysis to determine if any free isocyanate groups remain in the reactor. Additional samples are periodically taken until the IR spectrum indicates that the urethane acrylate in the sample is free of unreacted isocyanate groups, as evidenced by the disappearance of an output signal at about 2283 wave numbers in the IR spectrum. Preferably, all of the free isocyanate groups in the reactor are consumed over a reaction time of less than or equal to 150 minutes, more preferably from 120 to 150 minutes. Again, the reaction time is dependent on the scale of the reaction, the physical ability of the isocyanate component and the functionalized acrylate component to sufficiently mix, agitation of the mixture of the isocyanate component and the functionalized acrylate component, and control of the reaction temperature in the reactor. For example, if the reaction is limited by a rate that the isocyanate component is fed into the reactor, reaction time may increase. Furthermore, if a cooling efficiency of the reactor is low, the rate that the isocyanate component is fed into the reactor is reduced and the total reaction time may increase to compensate for the low cooling efficiency of the reactor. Likewise, if a cooling efficiency of the reactor is high, the rate that the isocyanate component is fed into the reactor may be increased and the total reaction time may decrease.

Preferably, the method further includes the step of adding a urethane catalyst to the functionalized acrylate component to promote the reaction between the isocyanate component and the functionalized acrylate component. The addition of the urethane catalyst significantly reduces the reaction time, thus making the reaction between the isocyanate component and the functionalized acrylate component more efficient. When added, the urethane catalyst is most preferably added to the functionalized acrylate component along with the inhibitor in the reactor. In the most preferred embodiment the urethane catalyst is a transition metal catalyst. Preferably, the transition metal catalyst includes organic tin compounds such as, but not limited to, tin (II) salts of organic carboxylic acids, e.g., tin (II) acetate, tin (II) octoate, tin (II) ethylhexanate and tin (II) laurate, and the dialkyltin (IV) salts of organic carboxylic acids, e.g., dibutyltin diacetate, dibutyltin dilaurate, dibutyltin maleate, dioctyltin diacetate, and combinations thereof. When aromatic isocyanates are used, the urethane catalyst is most preferably dibutyltin dilaurate, which is commercially available from Air Products and Chemicals under the trade name DABCO® T12. Alternatively, when aliphatic isocyanates are used, the urethane catalyst is most preferably tin carboxylate, which is commercially available from Witco Chemicals under the trade name Fomrez® UL-28.

Preferably, the total amount of urethane catalyst present in the urethane acrylate is from 0.001 to 0.10 parts by weight, based on the total weight of the urethane acrylate. More preferably, the total amount of urethane catalyst present is from 0.025 to 0.075 parts by weight, most preferably from 0.045 to 0.055 parts by weight, based on the total weight of the urethane acrylate. It is to be understood that amounts of less than 0.001 parts by weight of the catalyst based on the total weight of the urethane acrylate may be used to promote the reaction between the isocyanate component and the functionalized acrylate component but the reaction rate will be similar to the non-catalyzed reaction. Furthermore, it is to be appreciated that the urethane catalyst may be present in amounts greater than 0.1 parts by weight, based on the total weight of the urethane acrylate, without affecting the properties of the final urethane acrylate.

Many urethane acrylates have a high viscosity, making it difficult to use the urethane acrylate in a spray application to produce the coatings or structural composites. The viscosity of the urethane acrylates may be adjusted by varying the functionalized acrylate components according to the number of functional groups per functionalized acrylate component and by varying the amount of the functionalized acrylate component with respect to the isocyanate component while maintaining a stoichiometric excess of the functionalized acrylate component, more specifically the isocyanate-reactive functional groups present in the functionalized acrylate component, with respect to the isocyanate component. The excess functionalized acrylate component functions as a reactive diluent for lowering the viscosity of the urethane acrylate. Preferably, the stoichiometric excess of the functionalized acrylate component is defined as a range of molar equivalent ratios of the functionalized acrylate component to the isocyanate component from 3:1 to 1.05:1. More preferably, the stoichiometric excess is defined as a range of molar equivalent ratios of from 2.5:1 to 1.05:1. In a most preferred embodiment, the stoichiometric excess is defined as a range of molar equivalent ratios of from 2:1 to 1.05:1. The actual amounts by weight of the functionalized acrylate component and the isocyanate component will vary depending on the specific acrylate or mixture of acrylates used, as well as with the specific isocyanate and/or isocyanate mixture used.

Further, the viscosity of the urethane acrylate can be reduced through the use of reactive diluents other than the stoichiometric excess of the functionalized acrylate component, non-reactive diluents, and application of heat to the urethane acrylate. When used, the reactive diluent is preferably added in an amount of less than or equal to 50 parts by weight, more preferably from 5 to 25 parts by weight, and most preferably from 7 to 15 parts by weight, based on the total weight of the urethane acrylate. Alternatively, when the non-reactive diluent is used, the non-reactive diluent is preferably added in an amount of from 5 to 10 parts by weight based on the total weight of the urethane acrylate.

The viscosity of the urethane acrylate must be sufficiently low to enable spraying of the urethane acrylate during subsequent manufacturing processes; however, it is to be appreciated that the urethane acrylate may also be poured or injected, which may alter desired viscosity ranges for the urethane acrylate used in the processes. More specifically, the viscosity of the final urethane acrylate is preferably from 500 to 55000 centipoise at 25° C., more preferably from 1000 to 15000 centipoise at 25° C., and most preferably from 2000 to 2800 centipoise, based on measurements on a Brookfield® RVT viscometer at 60 rpm using a number 3 spindle. For a typical spray application the viscosity of the unfilled urethane acrylate composition should be in a range of 300 to 1000 centipoise. If it is desired to add fillers, such as but not limited to calcium carbonate, to the urethane acrylate composition, the viscosity of the unfilled urethane acrylate composition is preferred to be in the range of 150 to 300 centipoise. Once the filler is added to the urethane acrylate composition the viscosity can be further adjusted with reactive and non-reactive diluents, and/or heating the urethane acrylate composition to obtain the required viscosity for processing.

Furthermore, as a result of the presence of the inhibitor in the urethane acrylate and the action of the inhibitor during the reaction between the isocyanate component and the functionalized acrylate component, the urethane acrylate is stable at a temperature 60° C. for a period of at least 11 days. A stable urethane acrylate indicates a urethane acrylate that, through visual observation, does not separate into discrete layers, has no precipitated solids either suspended in the urethane acrylate or forming a layer on the bottom of the container holding the urethane acrylate, and/or has no gelled material present, either suspended or precipatated. Conversely, an unstable urethane acrylate is either separated into discrete layers, has solids evident on the bottom of the container holding the urethane acrylate, has solids suspended in the urethane acrylate as indicated by an opaque and milky consistency that is visibly distinguishable from a stable urethane acrylate, which is colorless to brownish in color and transparent, or has formed gel material either suspended or precipitated or that is non-flowable within the container. As a general rule, for each decrease of 10° C., the number of days double over which the urethane acrylate remains stable. For example, the urethane acrylate produced according to the method of the subject invention would be expected to remain stable for a period of at least 22 days at a temperature of 50° C., 44 days at a temperature of 40° C., and so forth. Thus, the urethane acrylate will remain stable at room temperature of about 25° C. for a period in excess of 90 days, which is a sufficient amount of time for many manufacturing processes.

Although visual observation for separation and/or solids precipitation is convenient and sufficient for determining stability of the urethane acrylate, the viscosity of the urethane acrylate may also be used to determine when separation has taken place. More specifically, the viscosity of the urethane acrylate is measured over periodic time intervals. An increase in viscosity of greater than 10% over an original viscosity of the urethane acrylate indicates instability.

Furthermore, the method may include an additional step of adding a metal salt to the urethane acrylate. The addition of the metal salt to the urethane acrylate lengthens the period over which the urethane acrylate remains stable. Preferably, the metal salt is further defined as cobalt carboxylate, which is commercially available from OMG America under the trade name 12% Cobalt Cem-all. The cobalt carboxylate is added to the urethane acrylate after all of the free isocyanate groups are consumed in the reactor. The urethane acrylate including the cobalt carboxylate, in addition to the inhibitor, remains stable at a temperature of 60° C. for a period of about 50 days. Thus, the urethane acrylate including the cobalt carboxylate will remain stable at room temperature of 25° C. for a period in excess of 400 days, according to the calculations discussed above.

The following examples, illustrating the method of producing the urethane acrylate, are intended to illustrate and not to limit the invention. The amounts set forth in these examples are by weight, unless otherwise indicated.

### EXAMPLES 1-4

The urethane acrylate is produced in accordance with the method of the subject invention. A 5 liter, 4-necked round bottom flask is used as the reactor. The reactor is inspected, cleaned, and purged with air that is free of moisture. The reactor is then charged with the functionalized acrylate component, the inhibitor, and the urethane catalyst. Agitation is started using an agitator operating at about 250 rpm. The reactor is cooled to the temperature of less than or equal to 20° C. The agitation is continued for between 30 and 60 minutes to dissolve and disperse the inhibitor and the urethane catalyst in the functionalized acrylate component while maintaining the temperature of less than or equal to 20° C. in the reactor. The isocyanate component is then fed into the reactor over an isocyanate feed period. The temperature in the reactor is maintained at or below a feed temperature while the isocyanate component is fed into the reactor. Once all of the isocyanate component is fed into the reactor, the reaction temperature is maintained within a reaction temperature range. A sample is taken from the reactor at about 120 minutes after feeding of the isocyanate component into the reactor is started. The sample is analyzed for remaining unreacted isocyanate groups by IR spectroscopy. If the sample includes unreacted isocyanate groups, the reaction is allowed to continue and additional samples are periodically taken every 30 minutes thereafter until the IR spectrum indicate that no unreacted isocyanate groups remain in the reactor, as will be evidenced by the disappearance of the IR signal at about 2283 wave numbers. Once the reaction is complete, a 2-4 ounce sample is then taken from the reactor to measure viscosity. The viscosity of the sample is measured on the Brookfield® viscometer at 25° C. The components and properties of the specific examples are indicated in Table 1below, wherein all values are parts by weight based on the total weight of the final urethane acrylate, unless otherwise indicated.

TABLE 1

| | Component | Ex. 1 | Ex. 2 | Ex. 3 | Ex. 4 | Ex. 5 |
|---|---|---|---|---|---|---|
| | Functionalized | 66.07 | 57.18 | 70.31 | 69.06 | 0.00 |
| | Acrylate | | | | | |
| | Component A | | | | | |
| | Functionalized | 0.00 | 0.00 | 0.00 | 0.00 | 78.59 |
| | Acrylate | | | | | |
| | Component B | | | | | |
| | Inhibitor | 0.03 | 0.03 | 0.03 | 0.05 | 0.03 |
| | Urethane Catalyst | 0.05 | 0.05 | 0.05 | 0.09 | 0.05 |
| Isocyanate | Isocyanate A | 33.85 | 0.00 | 8.07 | 15.40 | 21.33 |
| Component | Isocyanate B | 0.00 | 42.74 | 0.00 | 0.00 | 0.00 |
| | Isocyanate C | 0.00 | 0.00 | 10.77 | 7.70 | 0.00 |
| | Isocyanate D | 0.00 | 0.00 | 10.77 | 7.70 | 0.00 |
| | Total | 100.00 | 100.00 | 100.00 | 100.00 | 99.98 |
| | Isocyanate Feed | 30 | 60 | 60 | 60 | 60 |
| | Period, Minutes | | | | | |
| | Reaction Time, | 240 | 120 | 180 | 180 | 180 |
| | Minutes | | | | | |
| | Feed Temperature, ° C. | 45 | 35 | 45 | 35 | 35 |
| | Reaction | 35-40 | 35-40 | 40-45 | 35-40 | 35-40 |
| | Temperature | | | | | |
| | Range, ° C. | | | | | |
| | Viscosity, Cps | 2400 | 2030 | 675 | 1000 | 18500 |
| | Time Stable at | 11 | — | — | — | — |
| | 60° C., Days | | | | | |
| | Time Stable at | >90 | >100 | >90 | >90 | >7 |
| | 25° C., Days | | | | | |

Functionalized Acrylate Component A is a 98% hydroxyethyl methacrylate (HEMA) solution, commercially available from Degussa.

Functionalized Acrylate Component B is glycerin 1,3-dimethacrylate.

Inhibitor is butylated hydroxytoluene (BHT).

Urethane Catalyst is dibutyltin dilaurate commercially available from Air Products and Chemicals, Inc.

Isocyanate A is a polymeric diphenylmethane diisocyanate (PMDI) with an actual functionality of approximately 2.7 and a NCO content of approximately 31.5 parts by weight, commercially available from BASF Corp.

Isocyanate B is a hexamethylene diisocyanate homopolymer with an actual functionality of approximately 3.5 and a NCO content of approximately 21.6 parts by weight, commercially available from Bayer Corporation.

Isocyanate C is a diphenylmethane diisocyanate (MDI) with an actual functionality of approximately 2.0 and a NOC content of approximately 48.3 parts by weight based on the total weight, commercially available from BASF Corp.

Isocyanate D is toluene diisocyanate (TDI) with a functionality of approximately 2.0 and a NCO content of approximately 33.5 parts by weight, commercially available from BASF Corp.

### EXAMPLE 6

Another urethane acrylate is produced in accordance with the method of the subject invention. Again, the 5 liter, 4-necked round bottom flask is used as the reactor. The reactor is inspected, cleaned, and purged with air that is free of moisture. The reactor is then charged with the functionalized acrylate component, the inhibitor, the reactive diluent, and the urethane catalyst. Agitation is started using an agitator operating at about 250 rpm. The reactor is cooled to the temperature of less than or equal to 20° C. The agitation is continued for about 15 minutes to dissolve and disperse the inhibitor and the urethane catalyst in the functionalized acrylate component while maintaining the temperature of less than or equal to 20° C. in the reactor. The isocyanate component is then fed into the reactor over an isocyanate feed period. The temperature in the reactor is maintained at or below a feed temperature while the isocyanate component is fed into the reactor. Once all of the isocyanate component is fed into the reactor, the reaction temperature is maintained within a reaction temperature range. A sample is taken from the reactor at about 120 minutes after feeding of the isocyanate component into the reactor is started. The sample is analyzed for remaining unreacted isocyanate groups by IR spectroscopy. Since the sample included unreacted isocyanate groups, the reactor is then heated to a second reaction temperature, with additional samples taken every 30 minutes until the reaction is complete. Once the reaction is complete, a 2-4 ounce sample is then taken from the reactor to measure viscosity. The viscosity of the sample is measured on the Brookfield® viscometer at 25° C. The components and properties of Example 6 are indicated in Table 2 below, wherein all values are parts by weight based on the total weight of the final urethane acrylate, unless otherwise indicated.

TABLE 2

| Component | Ex. 6 |
|---|---|
| Functionalized Acrylate Component A | 38.62 |
| Inhibitor | 0.03 |
| Urethane Catalyst | 0.05 |
| Reactive Diluent | 25.30 |
| Isocyanate A | 36.00 |
| Total | 100.00 |
| Isocyanate Feed Period, Minutes | 60 |
| Reaction Time, Minutes | 420 |
| Feed Temperature, ° C. | 35 |
| Reaction Temperature Range, ° C. | 40-45 |
| Second Reaction Temperature, ° C. | 55 |
| Viscosity, Cps | 502 |
| Time Stable at 60° C., Days | >50 |

Functionalized Acrylate A, Inhibitor, Urethane Catalyst, and Isocyanate A are the same as set forth above in Examples 1-5.

Reactive Diluent is methyl methacrylate.

### COMPARATIVE EXAMPLE

The comparative example is performed according to a conventional method of preparing a urethane acrylate. An open-top vessel equipped with an overhead stirrer is used as the reactor. The reactor is inspected, cleaned, and purged with air that is free of moisture. The reactor is then charged with the functionalized acrylate component, absent the urethane catalyst and absent the inhibitor. Agitation is started using an agitator operating at about 250 rpm and the isocyanate component is fed into the reactor over a period of about 60 minutes. The temperature in the reactor remained relatively constant at 25° C. while the isocyanate component is fed into the reactor. After an induction period of about 30 minutes after the feeding of the isocyanate component into the reactor is started, the reaction temperature rapidly increased to over 100° C. However, as the reaction temperature approached 80° C., limited cooling is applied to the reactor. The functionalized acrylate component and the isocyanate component were allowed to react and after about 240 minutes, the mixture is cooled to about 60° C. After a total of 360 minutes, the IR spectrum showed that unreacted isocyanate groups remained in the reactor and the mixture is allowed to stand without heating until the reaction is complete. After standing for about 3 days, the urethane acrylate formed a solid gel. The components and properties of the Comparative Example are indicated in Table 3 below, wherein all values are parts by weight based on the total weight of the final urethane acrylate, unless otherwise indicated.

TABLE 3

| Component | Comparative Example |
|---|---|
| Functionalized Acrylate Component A | 66.10 |
| Isocyanate A | 33.90 |
| Total | 100.00 |
| Viscosity, Cps | Solid gel |
| Time Stable at 60° C., Days | none |

Functionalized acrylate A and Isocyanate A are the same as set forth above in Examples 1-5.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

1. A method of producing a urethane acrylate comprising the steps of:
charging a reactor with the functionalized acrylate component;
combining an inhibitor with a functionalized acrylate component;
reacting an isocyanate component and the functionalized acrylate component in the presence of the inhibitor to produce the urethane acrylate; and
maintaining a reaction temperature at less than 60° C. in the reactor throughout said step of reacting the isocyanate component with the functionalized acrylate component.

2. A method as set forth in claim 1 wherein the reaction temperature is maintained at less than or equal to 55° C.

3. A method as set forth in claim 2 wherein the reaction temperature is maintained at less than or equal to 50° C.

4. A method as set forth in claim 1 further comprising the step of dissolving the inhibitor in at least one of the isocyanate component and the functionalized acrylate component.

5. A method as set forth in claim 1 wherein the inhibitor comprises an antioxidant having a functional group that is sterically hindered.

6. A method as set forth in claim 5 wherein the inhibitor comprises a hindered phenol.

7. A method as set forth in claim 6 wherein the inhibitor comprises a compound having the formula: 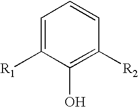
wherein R₁ and R₂ each comprise at least one of an aliphatic group, an aromatic group, and combinations thereof having from one to twenty carbon atoms.

8. A method as set forth in claim 7 wherein the inhibitor is selected from the group of a 3,5-bis-(1,1-dimethyl-ethyl)-4-hydroxy benzennepropanic ester of a C14-C15 alcohol blend, butylated hydroxytoluene, triethylene glycol-bis-3,3-t-butyl-4 hydroxy-5 methyl phenyl propionate, pentaerythritol tetrakis [3-(3,5-di-tert-butyl-4-hydroxphenyl)propionate], octadecyl-3,5-di-(tert)-butyl-4-hydroxyhydrocinnamate, a 3,5-bis(1,1-dimethyl-ethyl)-4-hydroxy-C₇-C₉ branched alkylester, 2,2′-methylene-bis(6-t-butyl-4-methylphenol), 2,6-di-tertiary-butyl-4-nonylphenol, a butylated reaction product of p-cresol and dicyclopentadiene, tocopherol, and combinations thereof.

9. A method as set forth in claim 1 wherein the isocyanate component has at least two isocyanate groups.

10. A method as set forth in claim 9 wherein the isocyanate component is selected from the group of toluene diisocyanates, polymeric diphenylmethane diisocyanates, diphenylmethane diisocyanates, and combinations thereof.

11. A method as set forth in claim 9 wherein the isocyanate component comprises a prepolymer.

12. A method as set forth in claim 9 wherein the functionalized acrylate component has at least one functional group that is reactive with at least one of the isocyanate groups.

13. A method as set forth in claim 12 wherein the functional group is selected from the group of hydroxy-functional groups, amine-functional groups, and combinations thereof.

14. A method as set forth in claim 13 wherein the functionalized acrylate component has from one to four olefinic functional groups and from one to four isocyanate reactive functional groups.

15. A method as set forth in claim 13 wherein the functional group comprises an alkyl group having from one to twenty carbon atoms.

16. A method as set forth in claim 1 comprising the step of reacting the isocyanate component with a stoichiometric excess of the functionalized acrylate component.

17. A method as set forth in claim 1 comprising the step of cooling the functionalized acrylate component and the reactor to a temperature of less than 20° C. prior to said step of reacting the isocyanate component and the functionalized acrylate component.

18. A method as set forth in claim 1 comprising the step of feeding the isocyanate component into the reactor separate from the functionalized acrylate component.

19. A method as set forth in claim 18 wherein said step of feeding the isocyanate component into the reactor occurs over a period of at least 30 minutes.

20. A method as set forth in claim 18 comprising the step of maintaining the reaction temperature at less than or equal to 40° C. throughout said step of feeding the isocyanate component into the reactor.

21. A method as set forth in claim 18 comprising the step of maintaining the reaction temperature within a temperature range of from 40 to 50° C. until all free isocyanate groups are consumed in the reactor.

22. A method as set forth in claim 18 wherein all free isocyanate groups in the reactor are consumed over a period of less than or equal to 150 minutes.

23. A method as set forth in claim 1 further comprising the step of adding a urethane catalyst to at least one of the isocyanate component and the functionalized acrylate component.

24. A method as set forth in claim 1 further comprising the step of adding a reactive diluent to the functionalized acrylate component.

25. A method as set forth in claim 1 wherein the urethane acrylate has a viscosity of from 500 to 55000 centipoise.

26. A method as set forth in claim 1 wherein the urethane acrylate is stable at a temperature of 60° C. for a period of at least 11 days.

27. A method as set forth in claim 1 further comprising the step of adding a metal salt to the urethane acrylate.

28. A method as set forth in claim 27 wherein the metal salt comprises cobalt carboxylate.

29. A method as set forth in claim 28 wherein the urethane acrylate is stable at a temperature of 60° C. for a period of at least 44 days.
